(19) United States
(12) Patent Application Publication
(10) Pub. No.: US 2002/0029573 A1
(43) Pub. Date: Mar. 14, 2002

(54) Method for reducing thermoacoustic vibrations in turbo machines with a burner system

(76) Inventors: Ephraim Gutmark, Cincinnati, OH (US); Christian Oliver Paschereit, Baden (CH); Wolfgang Weisenstein, Remetschwil (CH)

Correspondence Address: BURNS DOANE SWECKER & MATHIS L L P, POST OFFICE BOX 1404, ALEXANDRIA, VA, 22313-1404, US

(21) Appl. No.: 09/932,092

(22) Filed: Aug. 20, 2001

(30) Foreign Application Priority Data
Aug. 21, 2000 (DE) 100 40 868.0

(51) Int. Cl. F02C 7/24

(52) U.S. Cl. 60/722; 60/725

(57) ABSTRACT

Described is a method for reducing thermoacoustic vibrations in turbo machines with a burner system which provides at least one burner, into which burner is injected fuel through at least one burner nozzle, said fuel being mixed with the combustion supply air flowing into the burner and forming a fuel/air mixture that is ignited in a combustor following the burner system.

The invention is characterized in that the fuel is pulsed through the burner nozzle into the burner with variable or fixed frequencies between 1 Hz and 1,000 Hz.

### FIELD OF THE INVENTION

The invention relates to a method for reducing thermoacoustic vibrations in turbo machines with a burner system which provides at least one burner, into which burner is injected fuel through at least one burner nozzle, said fuel being mixed with the combustion supply air flowing into the burner and forming a fuel/air mixture that is ignited in a combustor following the burner system.

### BACKGROUND OF THE INVENTION

When operating turbo machines, such as, for example, gas turbine systems, undesirable, so-called thermoacoustic, vibrations often occur in the combustors. These thermoacoustic vibrations are generated at the burner in the form of fluidic instability waves and result in flow vortices that have a major effect on the entire combustion process and result in undesirable, periodic heat releases within the combustor that are associated with major fluctuations in pressure. These high fluctuations in pressure are coupled with high vibration amplitudes that can lead to undesirable effects, such as, for example, a high mechanical load on the combustor housing, increased NOₓ emissions caused by inhomogeneous combustion, and even an extinction of the flame within the combustor.

Thermoacoustic vibrations are based at least in part on flow instabilities of the burner flow that express themselves as coherent flow structures and influence the mixing processes between air and fuel.

In standard combustors, cooling air is passed in the form of a cooling air film over the combustor walls. In addition to the cooling effect, the cooling air film also has a sound-dampening effect and helps to reduce thermoacoustic vibrations. In modern high-efficiency gas turbine combustors with low emissions and constant temperature distribution at the turbine inlet, the cooling air flow into the combustor is clearly reduced, and the entire air is passed through the burner. However, at the same time the sound-dampening cooling air film is reduced, causing a reduction in the sound-dampening effect so that there is once again an increase in the problems associated with undesirable vibrations.

Another possibility for dampening the sound is the connection of so-called Helmholtz resonators near the combustor or cooling air supply. However, because of tight space conditions, it is very difficult to provide such Helmholtz resonators in modern combustion chamber designs.

It is also known that the fluidic instabilities and associated pressure fluctuations occurring in the burner can be countered by stabilizing the fuel flame with an additional injection of fuel. Such an injection of additional fuel is performed through the head stage of the burner that is provided with a jet for the pilot fuel gas supply located on the burner axis; however, this results in an over-rich central flame stabilization zone. This method of reducing thermoacoustic vibration amplitudes has the disadvantage, however, that the injection of fuel at the head stage may occur with increased NOₓ emissions.

It has been recognized that a pulsed addition of additional fuel through the head stage into the burner achieves a slight reduction of thermoacoustic vibrations, while the emission values deteriorate only slightly; however, the instabilities with high frequencies in the kHz range that form in the gas turbines because of thermoacoustic vibrations, in particular, cannot be sufficiently counteracted.

Especially instabilities in the fluid flow within the burner system with high frequencies are hard to control with previously known technical means. Attempts of active control, for example, by targeted introduction of anti-sound fields into the burner system in order to suppress the high-frequency pressure fluctuations, failed because of a lack of suitable actuators that should be able to generate pressure vibrations with a high amplitude in a targeted manner. In addition, such actuators should be able to respond quickly and be able to generate response signals at an appropriate level to correspondingly obtained instability signals. However, such actuators are neither available with the desired characteristics, nor are they feasible financially and with respect to their susceptibility during operation.

### SUMMARY OF THE INVENTION

The invention is based on the objective of further developing a method for reducing thermoacoustic vibrations in turbo machines with a burner system which provides at least one burner, into which burner is injected fuel through at least one burner nozzle, said fuel being mixed with the combustion supply air flowing into the burner and forming a fuel/air mixture that is ignited in a combustor following the burner system in such a way that high-frequency, thermoacoustic vibrations can be suppressed effectively and without the need for expensive and high-maintenance components.

The realization of the objective of the invention is described in claim 1. Characteristics that constitute advantageous further development of the invented concept are found in the secondary claims as well as in the specification.

According to the invention, the method according to the preamble of claim 1 provides that the high-frequency, combustion-driven vibrations, also called thermoacoustic vibrations, are suppressed with a low-frequency excitation of the fuel mass stream. According to the invention, the fuel is therefore pulsed through the burner nozzle into the burner at variable frequencies between 0.1 Hz and 1,000 Hz, preferably between 1 and 20 Hz.

Such a low-frequency, pulsed feeding of the main fuel into the burner for the purpose of further mixing into a fuel/air mixture makes it possible to use commercially available and reliably functioning actuators for the fuel excitation or fuel feeding.

The knowledge that unexpectedly forms the basis of this invention is the fact that, independently from the formation of thermoacoustic instabilities with a substantial high-frequency portion, a low-frequency modulation of the fuel mass stream through a pulsed fuel injection is able to suppress particularly the high-frequency portion of the thermoacoustic vibrations effectively.

So far, it was widely held that high-frequency instabilities could only be counteracted by feeding in high-frequency counter-vibrations. But when looking at the driving mechanism for the formation of thermoacoustic instabilities, one recognizes that these instabilities are based on the one hand on coherent vortex separations that occur, for example, immediately following the burner outlet, and on the other hand on mixing break fluctuations during the mixing of the fuel with the combustion supply air in the premixing stage. By influencing the phase relation between the fuel injection and periodic heat release with an excitation mechanism, the combustion instabilities can be controlled. In particular, the phase relation between the periodic heat release and fuel injection must be interrupted in such a way that the so-called Rayleigh criterion is no longer fulfilled. In this way, the driving mechanism for the occurrence of thermoacoustic vibrations can be suppressed.

In particular, in order to suppress the combustion-driven vibrations, the phases of the fuel injection and heat release must be correlated in such a way that the Rayleigh criterion is not fulfilled. The following applies:

G(x)=2∫|S_{pq} (x,f)|cos(M_{pq})df

S_{pq} hereby stands for the cross-spectrum between pressure fluctuations p′ and fluctuations of the heat release q′, and M_{pq} stands for the phase differential. By choosing the correct phase differential between the heat release, which can be influenced by the modulated fuel injection, and the pressure, the Rayleigh index can be set to G(x)<0, so that the system is dampened.

The suppression of the combustion-driven vibrations therefore is based on the fact that the phases of the fuel injection and heat release are not correlated so that the Rayleigh criterion would be fulfilled.

### BRIEF DESCRIPTION OF THE DRAWINGS

The invention is described in an exemplary manner below with the help of exemplary embodiments in reference to the drawing, without limiting the general concept of the invention. In the drawing:

FIG. 1 is a block diagram showing an employed control loop for suppressing thermoacoustic vibrations within a burner system; and,

FIG. 2 is a diagram showing the efficiency of the method according to the invention.

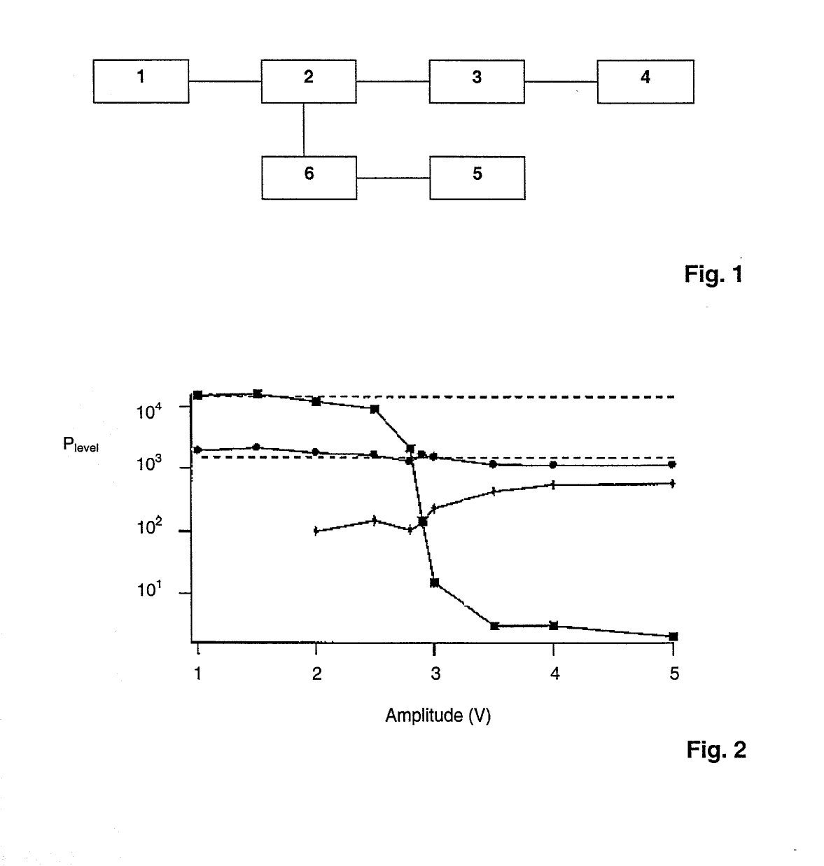

### DETAILED DESCRIPTION OF THE INVENTION

From a fuel reservoir 1, liquid or gaseous fuel is transported via an injection nozzle 2 into the inside of a burner 3, in which the atomized fuel forms, together with the combustion air, a fuel/air mixture that, after complete intermixing, reaches the combustor 4, where it is ignited and is available for further use for operation, for example, for a gas turbine.

The injection nozzle 2 can be controlled so that its nozzle opening can be closed, so that, depending on the control of the injection nozzle 2, a pulsed fuel introduction into the burner 3 is possible. For controlling the injection nozzle 2, a frequency generator 5 is provided, whose control signals are amplified with an amplification unit 6 and are then fed to the injection nozzle 2. Any desired frequency values that set the pulse frequency of the fuel introduction into the burner 3 can be set at the frequency generator 5. As a rule, empirically established frequencies at which an effective suppression of thermoacoustic instabilities can be observed are suitable for this purpose.

FIG. 2 shows a diagram clarifying the effect of the measure according to the invention for forming thermoacoustic vibrations in the kHz range.

In the diagram, the abscissa is marked with the amplitude values of the pressure vibrations, and the ordinate with a scale indicating the level of the formation of pressure vibrations.

The line containing the solid squares represents a main instability in the kHz range. By impressing a low-frequency excitation (see line with solid diamonds) with a frequency at 1.5% of the instability frequency, the high-frequency instability could be suppressed by 39 dB. Hereby only the amplitude of the excitation signal is changed; in the shown case in FIG. 2, its frequency remains the same.

A second instability with a somewhat smaller amplitude in the 100 Hz range (see line with solid circles) also could be further suppressed by approximately 2 dB.

It could also be observed that the amplitude of excitation only rose slightly and still was 5 dB below the level of the uncontrolled low-frequency instability and 14 dB below the level of the high-frequency vibration.

### List of Reference Numbers

1 Fuel reservoir

2 Injection nozzle

3 Burner

4 Combustor

5 Frequency generator

6 Amplification unit

1. Method for reducing thermoacoustic vibrations in turbo machines with a burner system which provides at least one burner (3), into which burner is injected fuel through at least one burner nozzle (2), said fuel being mixed with the combustion supply air flowing into the burner (3) and forming a fuel/air mixture that is ignited in a combustor (4) following the burner system, characterized in that
the fuel is pulsed through the burner nozzle (2) into the burner (3) with variable or fixed frequencies between 1 Hz and 1,000 Hz.

2. Method as claimed in claim 1, characterized in that
the pulsed fuel addition through the burner nozzle (2) is performed in such a way that the formation of the fuel/air mixture also takes place in a pulsed manner.

3. Method as claimed in claim 1 or 2, characterized in that
the pulsed fuel addition takes place independently from thermoacoustic vibrations forming in the burner system, i.e., in an open loop.

4. Method as claimed in claim 1 or 2, characterized in that
the pulsed fuel addition takes place at a frequency that is approximately 1.5% of the frequency at which the thermoacoustic vibrations form.

5. Method as claimed in one of claims 1 to 4, characterized in that
the fuel/air mixture flowing directly from the burner (3) is mixed as completely as possible during a premixing stage, before the mixture is ignited in the combustor(4).

6. Method as claimed in one of claims 1 to 5, characterized in that
for the formation of the fuel/air mixture a burner is used that comprises at least two hollow partial bodies stacked inside each other in flow direction of the fuel/air mixture; the center axes of which partial bodies extend offset to each other in such a way that adjoining walls of the partial bodies form tangential air inlet channels for the inflow of combustion air into an interior chamber defined by the partial bodies, and whereby the burner is provided with at least one axially arranged fuel nozzle through which the fuel is injected in a pulsed manner.

7. Method as claimed in one of claims 1 to 6, characterized in that
gas turbine systems are used as turbo machines.
